(19) United States
(12) Patent Application Publication
(10) Pub. No.: US 2002/0063088 A1
(43) Pub. Date: May 30, 2002

(54) Organic matter removal apparatus for effectively removing surfactants and other organic substances present in water to be treated

(76) Inventors: Masao Hidaka, Tokyo (JP); Madoka Tanabe, Tokyo (JP)

Correspondence Address: Rosenthal & Osha L.L.P., 700 Louisiana, Suite 4550, Houston, TX, 77002, US

(21) Appl. No.: 09/995,124

(22) Filed: Nov. 27, 2001

Related U.S. Application Data
(63) Continuation of application No. 09/639,554, filed on Aug. 16, 2000.

(51) Int. Cl. B01D 15/00

(52) U.S. Cl. 210/263

(57) ABSTRACT

Surfactants present in waste water to be treated are adsorbed and removed on a salt-form ion exchange resin by passing the water to be treated with the surfactants and other organic materials through an ion exchange apparatus using the salt-form ion exchange resin, with the waste water to be treated being generated from using high-purity water. The organic matter remaining in the treated water of the ion exchange apparatus is oxidized and decomposed by an organic matter oxidizing device. The obtained treated water is supplied to the high-purity water producing apparatus for recovery and reuse.

### BACKGROUND OF THE INVENTION

1. Field of the Invention

The present invention relates to an organic matter removal apparatus for effectively removing surfactants and other organic matter present within water to be treated. An organic matter removal apparatus according to the present invention can be suitably used, for example, on a waste water recovery line which carries waste water bearing surfactants and other organic substances and which constitutes a part of a system for producing high-purity water used as washing water in manufacturing processes for semiconductor devices and liquid crystal displays. In the specification, the term “high-purity water” is used for water having high purity such as deionized water and ultra pure water for which no general clear distinction is defined.

2. Description of the Related Art

An apparatus for producing high-purity water used as washing water in the manufacturing processes for semiconductor devices and liquid crystal displays typically includes, as shown in FIG. 7, a high-purity water producing system constructed from a primary deionized water system 2, and a secondary deionized water system (sub-system) 4, and a waste water recovery system for deionized water 6 which forms a part of a larger waste water recovery system of the factory. The primary deionied water system 2 is a route including, for example, a reverse osmosis membrane device, a vacuum degassing device, and an ion exchange apparatus. Pre-treated water 8, which is obtained at a pretreatment system (not shown) by removing suspended solids and a part of organic matter present in raw water such as city water or industrial water, is supplied to the primary deionized water system 2. The secondary deionized water system 4 is a route including, for example, an ultraviolet oxidizing device, a cartridge polisher, and an ultrafiltration device. The treated water 3 of the primary deionized water system 2 (primary deionized water) is supplied to the secondary deionized water system 4 via a deionized water storage tank 10. A portion of high-purity water 12 obtained at the secondary deionized water system 4 is sent to and used at use points 14, and the remaining high-purity water is circulated to the deionized water storage tank 10. The waste water recovery system for deionized water 6 is a route including, for example, an activated carbon filter device, an ion exchange apparatus, and an ultraviolet oxidizing device, and treats waste water 16 generated at the use points 14 where the high-purity water is used. Treated water 18 of the waste water recovery system for deionized water 6 is returned to the primary deionized water system 2 for reuse.

Though not shown, a typical high-purity water producing system includes, as waste water recovery systems for treating the waste waters 16 generated at the use points 14, in addition to the waste water recovery system for deionized water 6 for applying suitable treatment and returning the treated water to the primary deionized water system, a route for directly returning the waste water to the primary deionized water system without any treatment, a route for applying suitable treatment to the waste water for reuse as general purpose water (waste water recovery system for general purpose water), and a route for applying suitable treatment to the waste water for discharge (waste water treating system), depending on the strength of the waste water. In this case, in the waste water recovery system for deionized water, the waste water recovery system for general purpose water, and the waste water treating system, the organic matter present in the waste waters from the use points is generally removed by suitable organic matter removal means.

In such a system for producing high-purity water used in the manufacturing processes for semiconductor devices, liquid crystal displays, etc., as described above, it is typical practice to include waste water recovery systems for treating waste waters generated as a result of the use of the high-purity water at the use points to reuse the recovered water as raw water for high-purity water and as general purpose water. By providing the waste water recovery systems, the factory can solve a problem of deficiency of raw water for high-purity water such as city water and industrial water, and comply with waste water discharge regulations. Thus, advantages can be obtained as source water can be effectively used and the environment can be protected. On the other hand, it has become important to have good operation management of the devices that form the waste water recovery systems.

In recent semiconductor device manufacturing processes and liquid crystal display manufacturing processes, surfactants are used for improving the washing effects in the washing steps using chemical reagents, and the consumption of such surfactants has been increasing. Consequently, concentrations of surfactants present in waste high-purity water discharged from the use points have increased. It is also generally the case that the waste high-purity water from use points includes organic matter such as isopropyl alcohol in addition to surfactants.

When treating waste water bearing surfactants and other organic substances as described above by the waste water treating systems forming parts of the high-purity water producing system, it is necessary to perfectly remove almost all surfactants and other organic substances, especially the surfactants. That is, if a surfactant remains in the treated water of the waste water recovery system for deionized water, and when the treated water is passed through the ion exchange apparatus and reverse osmosis membrane device provided in the high-purity water producing system for deionization purposes, the surfactant would pollute these deionization units and significantly reduce their performances. For example, in the ion exchange apparatus, surfactants would be irreversibly adsorbed on the surface of the ion exchange resins. Thus these surfactants cannot be eluted by acid or alkali regenerants. This in turn results in reducing the reaction rate, and thus the purity, of the treated water. In the reverse-osmosis membrane device, surfactants would irreversibly adhere to the membrane surface and accumulate, resulting in reduction of the flux rate. If surfactants remain in the treated water from the waste water recovery system for general purpose water and from the waste water treating system, there are problems of the environmental pollution, etc.

Therefore, in all waste water recovery systems of the conventional high-purity water producing system, an activated carbon filter(s) is provided at the waste water system inlet in order to prevent surfactants from remaining in the treated water of the waste water recovery system by adsorbing and removing the surfactants on the activated carbon and then by oxidizing and decomposing any remaining surfactants by an organic matter oxidizing device.

In practice, however, problems caused by surfactants remaining in the treated water of the waste water recovery system are encountered. For example, in the case of the ion exchange apparatuses and reverse osmosis membrane devices of the high-purity water producing system, a performance reduction is often observed due to surfactants present in the treated water of the waste water recovery system for deionized water.

### SUMMARY OF THE INVENTION

One object of the present invention is to more effectively remove surfactants and other organic substances present in waste high-purity water generated at use points, for example, as described above.

According to one aspect of the organic matter removal apparatus of the present invention, surfactants in the water to be treated can be removed by a salt-form ion exchange resin. Moreover, the organic matter in the water to be treated can be removed by an organic matter oxidizing device. Therefore, it is possible to prevent environmental pollution by surfactants when the treated water is discharged. When the treated water is directed into the high-purity water producing apparatus, it is possible to prevent surfactants from causing a reduction in performance of the ion exchange apparatus and reverse osmosis device provided in the high-purity water producing system.

### BRIEF DESCRIPTION OF THE DRAWINGS

FIG. 1 is a flowchart showing an embodiment of an apparatus for producing high-purity water incorporating an organic matter removal apparatus according to the present invention in a waste water recovery system.

FIG. 2 is a schematic drawing showing one example of an organic matter oxidizing device used for an organic matter removal apparatus according to the present invention.

FIG. 3 is a schematic drawing showing another example of an organic matter oxidizing device used for an organic matter removal apparatus according to the present invention.

FIG. 4 is a schematic drawing showing yet another example of an organic matter oxidizing device used for an organic matter removal apparatus according to the present invention.

FIG. 5 is a schematic drawing showing further example of an organic matter oxidizing device used for an organic matter removal apparatus according to the present invention.

FIG. 6(A) and 6(B) are flowcharts showing experimental devices.

FIG. 7 is a flowchart showing a typical high-purity water producing apparatus.

### DESCRIPTION OF THE PREFERRED EMBODIMENT

After examining conventional methods for removing surfactants using an activated carbon filter(s) and organic matter oxidizing device, it was recognized that: (1) The surfactants cannot be sufficiently adsorbed and removed on an activated carbon filter and the surfactants can easily leak from the activated carbon filter. (2) Because surfactants generally have large molecular weights, it is rare for a surfactant to be decomposed to organic acids and/or carbonic acid by the organic matter oxidizing device at the downstream position. Organic substances having large molecular weights remain as decomposition products of the surfactant in the treated water of the organic matter oxidizing device, and the decomposition products of the surfactant pollute the ion exchange apparatus and the reverse osmosis device at the downstream position, resulting in a performance reduction thereof. (3) As described, because surfactants that leak from the activated carbon filter are oxidized and decomposed at the organic matter oxidizing device, a large portion of the oxidizing energy is consumed at the organic matter oxidizing device for oxidizing and decomposing the surfactants. As a result, removal efficiency of organic matter other than the surfactants by the organic matter oxidizing device is reduced, and it becomes impossible to sufficiently remove organic matter other than surfactants.

As a result of further examination for solving the problems (1) through (3) described above, the present inventors concluded that, if an ion exchange apparatus which adsorbs and removes the surfactants by a salt-form ion exchange resin is provided before the organic matter oxidizing device in the route for treating the water to be treated having the surfactants and other organic substances so that the surfactants present in the water to be treated are removed by the ion exchange apparatus and if the water flowing out of the ion exchange apparatus is then introduced to the organic matter oxidizing device, it is possible to almost perfectly remove the surfactants from the water to be treated by the ion exchange apparatus and, at the same time, because almost no surfactant flows into the organic matter oxidizing device, oxidizing energy will no longer be consumed for oxidation and decomposition of the surfactants, resulting in an improvement in the removal efficiency of the organic substances at the organic matter oxidizing device and sufficient removal of the organic matter other than the surfactants by the organic matter oxidizing device.

According to a preferred aspect of the present invention, there is provided an apparatus for removing organic matter from water comprising an ion exchange apparatus using a salt-form ion exchange resin for adsorbing and removing surfactants present in water having surfactants and other organic substances by passing the water to be treated through the ion exchange resin, and an organic matter oxidizing device for oxidizing and decomposing the organic substances remaining in the treated water of the ion exchange apparatus.

The present invention is further described in detail hereinafter. In the organic matter removal apparatus according to the present invention, an ion exchange apparatus using a salt-form ion exchange resin is first provided. In this case, the salt-form of the ion exchange resin may include, but is not limited to, Cl-form and HCO₃-form of an anion exchange resin and Na-form and K-form of a cation exchange resin. It is also possible to use a gel type resin as the salt-form ion exchange resin, but it is preferable to use a MR type resin (macroreticular resin) or macroporous type resin because of their excellent adsorption ability and easier elution of adsorbed surfactants therefrom. For similar reasons, it is better to use an ion exchange resin having an acrylic matrix than to use an ion exchange resin having a styrene matrix.

As an anion exchange resin, a strong or weak basic anion exchange resin can be used, but, because surfactants more readily adhere to and are more easily removed from a strong electrolytic anion exchange resin, a strong basic anion exchange resin, being a strong electrolytic anion exchange resin, is preferable. The form of ion exchange resin, such as granular or fibrous, can be arbitrarily selected. It is possible to use, for example, AMBERLITE IRA-900™, AMBERLITE IRA-911™, AMBERLITE IRA-958™ (all of which are macroreticular strong basic anion exchange resins), AMBERLITE IRA-96SB™ (a macroreticular weak basic anion exchange resin), DIAION PA-306™, and DIAION PA-312™ (both of which are macroporous strong basic anion exchange resins).

Among the ion exchange resins, as a cation exchange resin, either a strong or a weak acidic cation exchange resin can be used, but for similar reasons given with regard to the above-described anion exchange resins, a strong acidic cation exchange resin which is a strong electrolytic cation exchange resin is preferable. The form of the ion exchange resin can be arbitrarily selected, such as granular and fibrous. Examples of cation exchange resins which can be used include, MR type resins such as AMBERLITE 200C™ and AMBERLITE 201B™, gel type resins such as AMBERLITE IR-120B™ and AMBERLITE IR-118™ (all of which are strong acidic cation exchange resins), AMBERLITE IRC-50™, AMBERLITE IRC-76™ (both of which are weak acidic cation exchange resins), and macroporous type resins such as DIAION PK-₂₀₈™ and DIAION PK-216™ (both of which are strong acidic cation exchange resins).

In the present invention, when surfactants present in the water to be treated mostly comprise cation surfactants, it is preferable to use an ion exchange resin apparatus having a single bed of a salt-form cation exchange resin because a salt-form cation exchange resin can effectively adsorb and remove the cation surfactants.

Similarly, when the surfactants present in the water to be treated are mostly anion surfactants, it is preferable to use an ion exchange resin apparatus having a single bed of a salt-form anion exchange resin because a salt-form anion exchange resin can effectively adsorb and remove the anion surfactants.

Furthermore, because a mixed bed or multiple beds of salt-form anion and cation exchange resins can effectively adsorb and remove both surfactants, when the surfactants present in the water to be treated are both cation surfactants and anion surfactants, it is preferable to use an ion exchange apparatus having a mixed bed or multiple beds of salt-form anion and cation exchange resins.

When the adsorption capacity of the salt-form ion exchange resin(s) charged in the ion exchange apparatus has dropped, the ion exchange resin can be regenerated by passing therethrough a NaCl solution or a mixture solution of NaCl and NaOH, or by passing first a NaOH solution and then a HCl solution.

As a salt-form ion exchange resin, it is also possible to use, in addition to a new ion exchange resin, a waste ion exchange resin that has been used for a long period of time as an ion exchange resin for a deionized water producing apparatus.

In the organic matter removal apparatus according to the present invention, an organic matter oxidizing device for oxidizing and decomposing organic matter is provided following the ion exchange apparatus using the salt-form ion exchange resin(s) as described above. In this case, a preferable organic matter oxidizing device includes, for example, any of (a) through (c) described hereinafter. In these devices, the organic matter is decomposed by a reaction with hydroxyl radicals produced by a reaction between ozone and an alkali or between ozone or hydrogen peroxide and ultraviolet rays.

(a) An organic matter oxidizing device for oxidizing and decomposing the organic matter present in the water to be treated by adding ozone to the water to be treated under an alkaline condition.

(b) An organic matter oxidizing device for oxidizing and decomposing the organic matter present in the water to be treated by adding hydrogen peroxide in the water to be treated and irradiating ultraviolet rays to the water to be treated.

(c) An organic matter oxidizing device for oxidizing and decomposing the organic matter present in the water to be treated by adding ozone to the water to be treated and irradiating ultraviolet rays to the water to be treated.

There is no limitation on the structure of the organic matter oxidizing device (a), but it is preferable that one of, and more preferably both of, the following conditions (1) and (2) is met.

(1) Ozone is added to the water to be treated by gas-liquid stirring and mixing means.

(2) Ozone is added to the water to be treated under an alkali condition with the pH of the water to be treated being greater than or equal to 9.7.

In other words, because ozone has a low solubility in water, when ozone is added to the water to be treated, ozone does not sufficiently dissolve in water with bubbling created by air diffuser plates and the oxidizing decomposition reaction does not efficiently take place, but, when gas-solid stirring and mixing means is used, ozone can sufficiently be dissolved in the water to be treated, resulting in efficient oxidizing decomposition of the organic matter. Therefore, the organic matter oxidizing device (a) had better satisfy the condition (1).

Here, by gas-liquid stirring and mixing means is meant means for mixing gas and liquid by stirring and dissolving the gas in the liquid. Examples of ozone dissolving method using such means includes, for example, a method of introducing the water to be treated and ozone to the suction side of a pump having a rotor, stirring and mixing the water to be treated and ozone by rotation of the rotor, dissolving ozone in the water to be treated by stirring and mixing, and sending the water to be treated with ozone dissolved to the treating system through pipes connected to the delivery side of the pump (ozone dissolving pump) and a method of supplying pressurized water flow with an ejector used in place of the pump mentioned above, stirring and mixing the water to be treated and ozone with the movement of the water flow, and dissolving ozone in the water to be treated. In addition, a line mixer or the like which has a sealed container provided in the pipe can also be used the sealed container having a stirring mechanism with a rotor.

In the organic matter oxidizing device (a), the decomposition rate of the organic matter is large for a pH of 9.7 or greater, more particularly for a pH between 9.7 and 11.0, and especially for a pH in a range between 10.0 and 10.5. Therefore, it is preferable that an organic matter oxidizing device (a) satisfies the condition (2).

In the organic matter oxidizing device (a), it is possible either to adjust the pH of the water to be treated and then dissolve ozone in the water to be treated, or to dissolve ozone in the water to be treated and then adjust the pH thereof, or simultaneously adjust the pH of the water to be treated and dissolve ozone. The oxidation decomposition reaction of the organic matter in the water to be treated begins immediately when ozone is added to the water to be treated under alkali condition, and the rate of oxidation decomposition reaction can be hastened by heating the water to be treated.

As an organic matter oxidizing device (b), a device can be used which has a hydrogen peroxide adding mechanism for adding hydrogen peroxide to the water to be treated and an ultraviolet rays irradiating mechanism which irradiates ultraviolet rays to the water to be treated with hydrogen peroxide added. In this case, a suitable amount of added hydrogen peroxide can be determined based on the amount of the organic matter desired to be removed. As an ultraviolet irradiating mechanism, a device having a high voltage ultraviolet lamp(s) which can irradiate ultraviolet rays with a wavelength around 365 nm is suitable.

As an organic matter oxidizing device (c), a device can be used which has an ozone adding mechanism for adding ozone to the water to be treated and an ultraviolet irradiating mechanism for irradiating ultraviolet rays to the water to be treated with ozone added. In this case, the amount of added ozone to the water to be treated can suitably be determined based on the amount of the organic matter desired to be removed. As an ultraviolet rays irradiating mechanism, a device having a high voltage ultraviolet lamp which can irradiate ultraviolet rays with a wavelength of around 365 nm is suitable.

Another example of an organic matter oxidizing device which can be preferably used for the present invention is (d) an organic matter oxidizing device for oxidizing and decomposing organic matter present in the water to be treated by adding persulfuric acid and/or a persulfate as an oxidizing agent(s) and heat treating the water to be treated with persulfuric acid and/or a persulfate added.

As the organic matter oxidizing device (d), a device can be used which has an oxidizing agent adding mechanism for adding persulfuric acid (H₂S₂O₈) and/or a persulfate to the water to be treated and a heat treating mechanism for heat treating the water to be treated with persulfuric acid and/or a persulfate added. In this case, as a persulfate, sodium peroxydisulfate (Na₂S₂O₈), potassium peroxydisulfate (K₂S₂O₈), ammonium peroxydisulfate ((NH₄)₂S₂O₈), or the like can be used. The heating temperature of the water to be treated at the heat treating mechanism is preferably 90° C. or higher, and more preferably between 110° C. and 150° C., with a suitable heat treating time between 1 and 15 minutes.

In the organic matter removal apparatus according to the present invention, when using the organic matter oxidizing devices (a) through (d), decomposing means can be provided downstream of the organic matter oxidizing devices (a) through (d), for decomposing the oxidizing agent such as ozone, hydrogen peroxide, a persulfate, etc. remaining in the treated water of the organic matter oxidizing device. In this manner, it is possible to prevent adverse effect of the oxidizing agents remaining in the treated water of the organic matter oxidizing device on the devices following the organic matter oxidizing device, such as an ion exchange apparatus or a membrane separation device. The decomposing means includes, for example, means for reducing and decomposing the oxidizing agent by passing the water to be treated through a column charged with activated carbon, a platinum catalyst, or a palladium catalyst, and means for reducing and decomposing the oxidizing agent by injecting reduction agent to the water to be treated. It is preferable that the decomposing means be provided immediately after the organic matter oxidizing device in order to prevent adverse effects of ozone, hydrogen peroxide or any other oxidizing agent on the devices further downstream.

The apparatus for producing high-purity water according to the present invention is an apparatus for producing high-purity water having a high-purity water producing system for producing high-purity water by treating raw water and a waste water recovery system for treating the waste water generated at use points by using the high-purity water produced at the high-purity water producing system, wherein an organic matter removal apparatus with an ion exchange apparatus and an organic matter oxidizing device mentioned above is provided at one or more of a route for suitably treating the waste water and returning to the primary deionized water system (waste water recovery system for deionized water), a route for suitably treating the waste water and using the recovered water as general purpose water (waste water recovery system for general purpose water), and a route for suitably treating the waste water for discharge (waste water treating system). In this case, by placing the organic matter removal apparatus of the present invention at the waste water recovery system for deionized water, performance reduction of the ion exchange apparatus and reverse osmosis membrane device provided at the high-purity water producing system due to surfactants can be prevented. By placing the-organic matter removal apparatus of the present invention at the waste water recovery system for general purpose water or at the waste water treating system, environmental pollution due to surfactants can be prevented.

The preferred embodiment of the present invention will be further described hereinafter in greater detail by referring to the attached drawings.

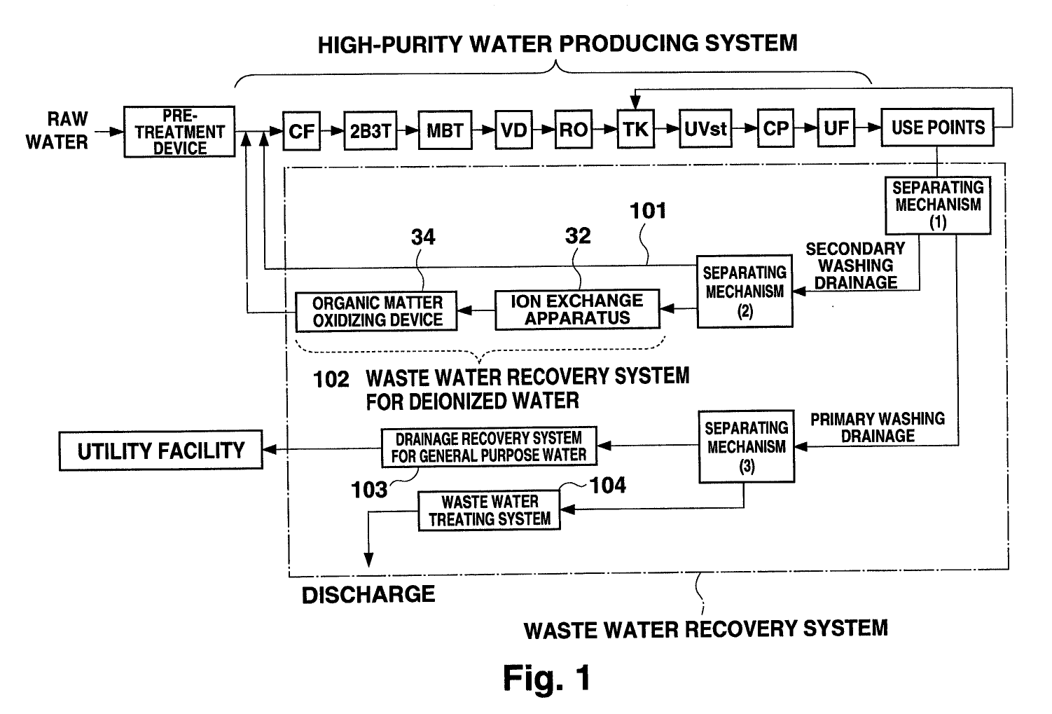

FIG. 1 is a flow chart of the preferred embodiment of a high-purity water producing system with an organic matter removal apparatus according to the present invention incorporated in the waste water recovery system. The high-purity water producing section of the system shown in FIG. 1 is constructed from a primary deionized water system with an activated carbon filter(s)(CF), a 2 bed ion exchange deionized water producing device (2B3T), a mixed bed deionized water producing device (MBP), a vacuum degasifier column (VD), and a reverse osmosis membrane device (RO), and a secondary deionized water system with a tank (TK), an ultraviolet sterilizing device (UVst), a mixed bed cartridge polisher (CP), and an ultrafiltration device (UF).

In the system shown in FIG. 1, as waste water recovery systems for treating the waste water generated by using the high-purity water at the use points, a route 101 for directly returning the waste water to the primary deionized water system without treatment, a route 102 for suitably treating the waste water and then returning the treated water to the primary deionized water system (waste water recovery system for deionized water), a route 103 for suitably treating the waste water and then supplying to utility facilities as general purpose water (waste water recovery system for general purpose water), and a route 104 for suitable treating the waste water and then discharging (waste water treating system) are provided for treating the waste water according to on its strength. The segregation of the waste high-purity water discharged from the use points to the routes 101 through 104 is performed by separating mechanisms (1) through (3).

In the waste water recovery system for deionized water 102 of the system shown in FIG. 1, an ion exchange apparatus 32 using a salt-form ion exchange resin and an organic matter oxidizing device 34 are sequentially provided. The ion exchange apparatus 32 is for adsorbing and removing surfactants present in the water to be treated by the salt-form ion exchange resin. The organic matter oxidizing device 34 is any one of the organic matter oxidizing devices (a) through (d) described earlier, and is for oxidizing and decomposing the organic matter remaining in the treated water of the ion exchange apparatus 32.

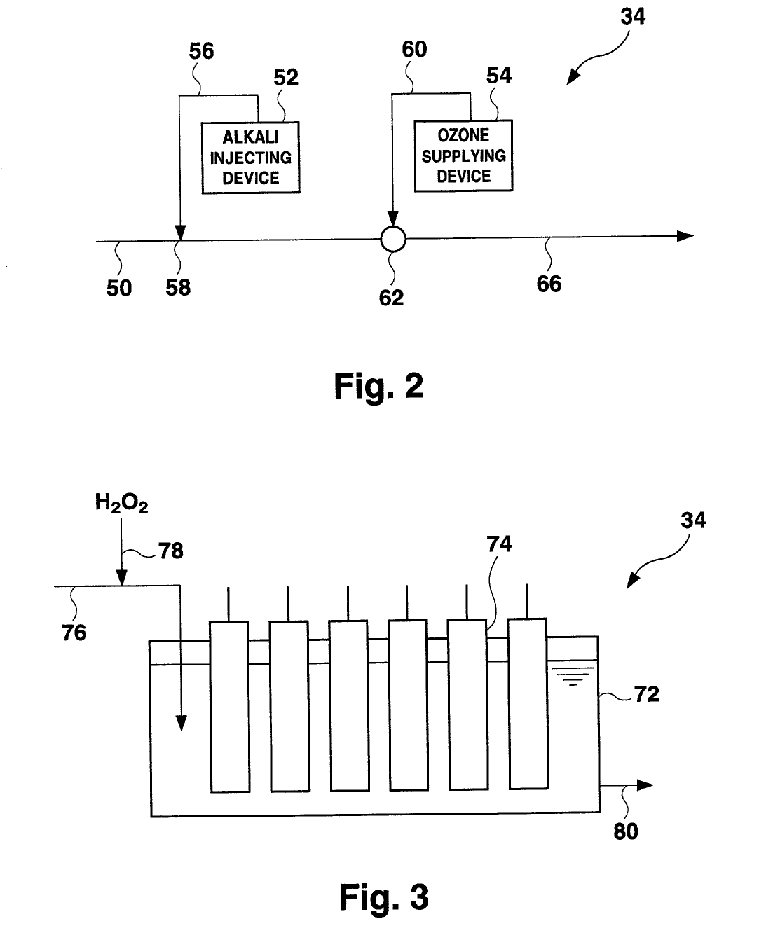

When device (a) is used as the organic matter oxidizing device 34 in the high-purity water producing system of the embodiment, a structure shown in FIG. 2 can, for example, be used as the organic matter oxidizing device (a). In FIG. 2, reference numeral 50 represents a line in which the water to be treated flows, and an alkali injecting device 52 and an ozone supplying device 54 are connected to the line 50. A pH measuring section (not shown) is provided behind a connecting section 58 between an injecting pipe 56 of the alkali injecting device 52 and the line 50. The pH of the water to be treated is measured by the pH measuring section, with the measurement result output as an electrical signal to the alkali injecting device 52 so that the amount of alkali added to the water to be treated is automatically controlled.

As an ozone supplying device 54, an ozone generator having an ozone generating mechanism, or an ozone tank loaded with ozone-containing gas generated by an ozone generator can be used. A gas-liquid stirring and mixing device 62 (such as, for example, a line mixer or an ozone dissolving pump) is connected to a supply pipe 60 of the ozone supplying device 54 and the gas-liquid stirring and mixing device 62 is connected to the line 50. A section of the line 50 forward from the exit side of the gas-liquid stirring and mixing device 62 with a predetermined length is configured as a reaction pipe section 66 in which the oxidation decomposition reaction of the organic matters take place.

In the organic matter oxidizing device (a) of the embodiment, the pH of the water to be treated flowing in the line 50 is adjusted to a value greater than or equal to 9.7, more preferably to a value between 9.7 and 11.0, by injecting an alkali from the alkali injecting device 52. Then, ozone is supplied to the waste water to be treated by the ozone supplying device 54, the ozone and the water to be treated are stirred and mixed by the gas-liquid stirring and mixing device 62 so that most of the ozone dissolves in the water to be treated. The amount of ozone added is adjusted, preferably to a value between 3 and 40 ppm, and more preferably to a value between 7 and 30 ppm. In the water to be treated, oxidation decomposition reaction of the organic matter quickly takes place in the reaction pipe section 66.

In the high-purity water producing system of the embodiment, when an organic matter oxidizing device (b) is used as the organic matter oxidizing device 34, a structure shown in FIG. 3, for example, can be used as the organic matter oxidizing device (b). In FIG. 3, reference numeral 72 represents an ultraviolet rays irradiating tank, reference numeral 74 represents high voltage ultraviolet lamps inserted in the ultraviolet rays irradiating tank 72 which can irradiate ultraviolet rays with a wavelength of at least around 365 nm, reference numeral 76 represents an inlet pipe connected to the ultraviolet rays irradiating tank 72 for the water to be treated, reference numeral 78 represents a hydrogen peroxide adding mechanism for adding hydrogen peroxide to the water to be treated flowing through the inlet pipe 76 for the water to be treated, and reference numeral 80 represents an exit pipe connected to the ultraviolet irradiating tank for the treated water. In the organic matter oxidizing device (b) of the embodiment, the organic matter present in the water to be treated is decomposed by first adding hydrogen peroxide to the water to be treated using the hydrogen peroxide adding mechanism 78, and then irradiating ultraviolet rays to the water to be treated with hydrogen peroxide added using an ultraviolet irradiating mechanism constructed from the ultraviolet irradiating tank 72 and the high voltage ultraviolet lamps 74.

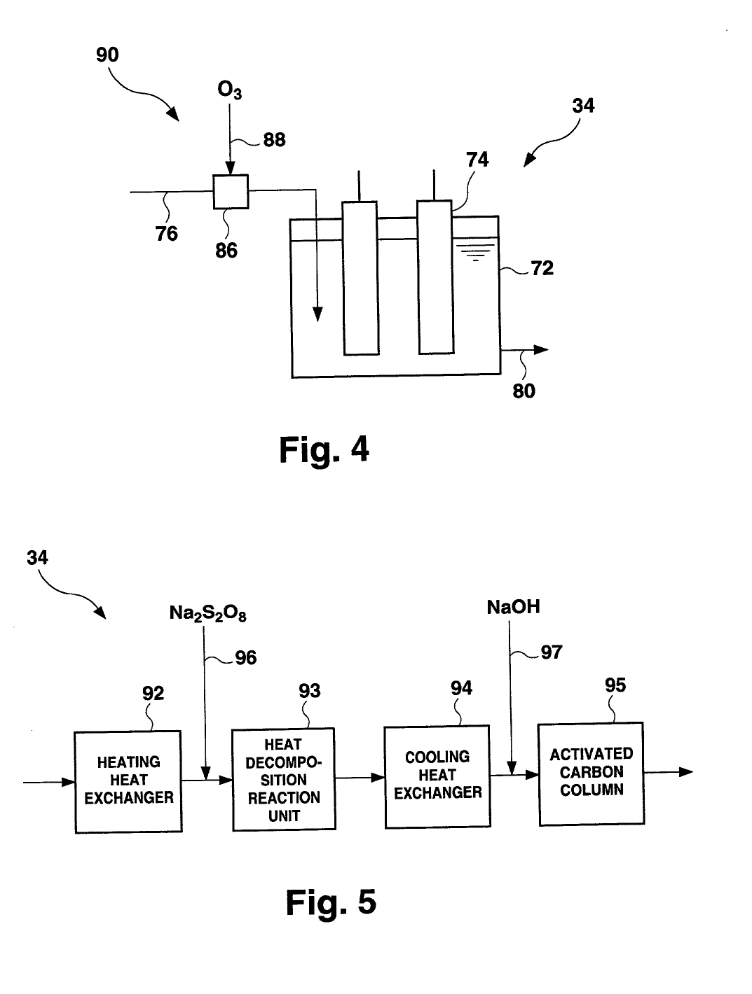

In the high-purity water producing system according to the embodiment, when an organic matter oxidizing device (c) is used as the organic matter oxidizing device 34, a structure shown in, for example, FIG. 4 can be used. In FIG. 4, components that are identical or equivalent to those shown in FIG. 3 are represented by the same reference numerals and will not be described again here. In the device shown in FIG. 4, the inlet pipe 76 for the water to be treated is equipped with a gas-liquid stirring and mixing device 86 (such as, for example, a line mixer or an ozone dissolving pump), and at the same time, an ozone supply pipe 88 is connected to the gas-liquid stirring and mixing device 86, to form an ozone adding mechanism 90 from the gas-liquid stirring and mixing device 86 and the ozone supply pipe 88 for adding ozone to the water to be treated flowing in the inlet pipe 76. In the organic matter oxidizing device (c) of the embodiment, the organic substances present in the water to be treated are decomposed by adding ozone to the water to be treated using the ozone adding mechanism 90 and then irradiating ultraviolet rays to the water to be treated with ozone added using the ultraviolet irradiating mechanism constructed from the ultraviolet irradiating tank 72 and the high voltage ultraviolet lamps 74.

In the high-purity water producing system according to the embodiment, when an organic matter oxidizing device (d) is used as an organic matter oxidizing device 34, a structure shown in FIG. 5, for example, can be used. In FIG. 5, reference numeral 92 represents a heating heat exchanger, reference numeral 93 represents a heat decomposition reaction unit, reference numeral 94 represents a cooling heat exchanger, reference numeral 95 represents an activated carbon column, reference numeral 96 represents an oxidizing agent adding mechanism, and reference numeral 97 represents a neutralizer adding mechanism. In the organic matter oxidizing device (d) of the embodiment, the organic matter is heat decomposed by first heating the water to be treated using the heating heat exchanger 92, adding Na₂S₂O₈ as an oxidizing agent, and heat decomposing at the heat decomposition reaction unit 93. After cooling the treated water of the heat decomposition reaction unit 93 at the cooling heat exchanger 94, NaOH is added for neutralization and remaining Na₂S₂O₈ is removed at the activated carbon column 95.

### EXAMPLES

### Examples 1 and 2, and Comparative Examples 1 through 3

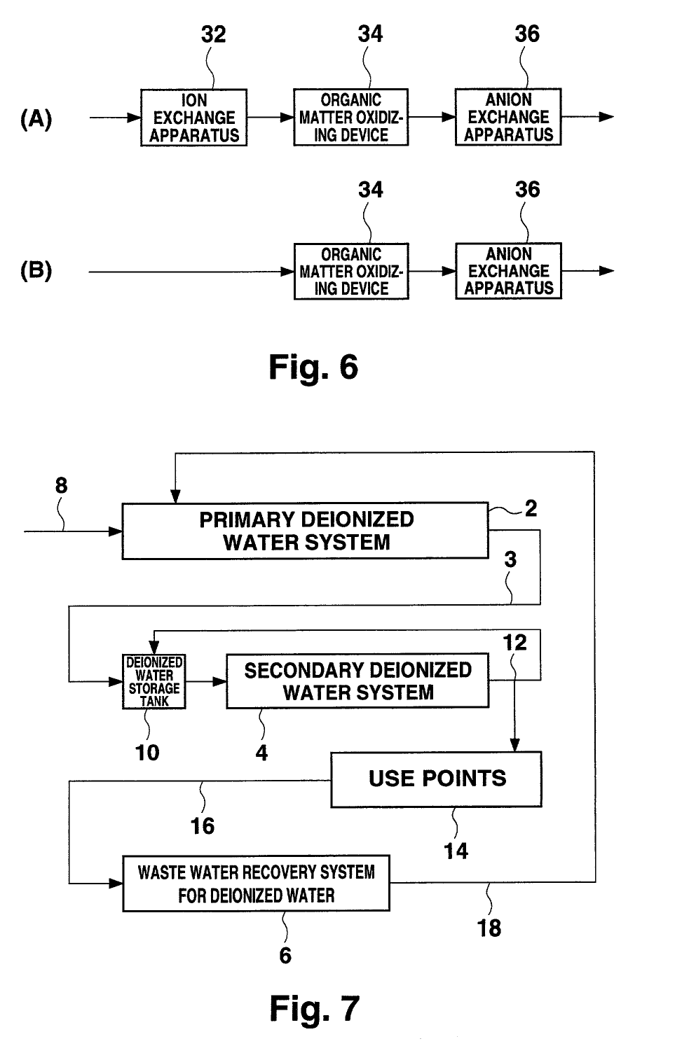

Experimental apparatuses according to the flow charts shown in FIG. 6(A) and 6(B) were prepared. The apparatus shown in FIG. 6(A) was provided, in sequence, with an ion exchange apparatus 32 using a salt-form ion exchange resin, an organic matter oxidizing device 34, and an anion exchange apparatus 36 using an anion exchange resin. The apparatus shown in FIG. 6(B) is an apparatus-similar to that shown in FIG. 6(A), except the ion exchange apparatus 32 was omitted.

At the ion exchange apparatus 32 in the apparatus shown in FIG. 6(A), a single bed of AMBERLITE IRA-958™ which is a Cl-form, MR type acrylic strong basic anion exchange resin was used. As an organic matter oxidizing device 34 in FIGS. 6(A) and 6(B), an organic matter oxidizing device (b) shown in FIG. 3 or an organic matter oxidizing device (c) shown in FIG. 4 were used. In the organic matter oxidizing devices (b) and (c), low voltage ultraviolet lamps were used in the ultraviolet irradiating mechanism.

In the organic matter oxidizing device (b), the amount of hydrogen peroxide added from the hydrogen peroxide adding mechanism 78 to the water to be treated was set at 40 mg/l and the amount of ultraviolet rays irradiated at the ultraviolet irradiating tank 72 was set at 3 KWh per 1 m3 of the water to be treated. In the organic matter oxidizing device shown in FIG. 4, the amount of ozone added to the water to be treated was set at 20 mg/l and the amount of ultraviolet rays irradiated at the ultraviolet irradiating tank 72 was set at 0.6 KWh per 1 m3 of the water to be treated. In the anion exchange apparatus 36, a single bed of AMBERLITE IRA-406BL™ which is an OH-form strong basic anion exchange resin was used.

Raw waste water containing anionic surfactants and other organic substances was passed through each of the experimental apparatuses shown in FIGS. 6(A) and 6(B). TOC concentrations within the raw water are shown in Table 1. The TOC concentration due to surfactants shown in Table 1 represents the TOC concentration which accounts for a part of the overall TOC concentration. The TOC concentrations of the water flowing out respectively from the ion exchange apparatus 32, the organic matter oxidizing device 34, and the anion exchange apparatus 36 are shown in Table 1.

| | | | | | TOC CONCENTRATION | | |
|---|---|---|---|---|---|---|---|
| | | | | | OF WATER FLOWING OUT (ppm) | | |
| | | | | | | WATER FLOW- | |
| | USED DEVICE | | TOC CONCENTRATION | | WATER FLOW- | ING OUT OF | WATER FLOW- |
| | | ORGANIC | OF THE RAW WATER (ppm) | | ING OUT OF | THE ORGANIC | ING OUT OF |
| | | MATTER | OVERALL TOC | TOC CONCENTRA- | THE ION EX- | MATTER OXI- | THE ANION EX- |
| | FLOW | OXIDIZING | CONCEN- | TION DUE TO | CHANGE | DIZING DEVICE | CHANGE |
| | DIAGRAM | DEVICE | TRATION | THE SURFACTANTS | APPARATUS 32 | 34 | APPARATUS 36 |
| EXAMPLE 1 | FIGURE | | 5.6 | 3.2 | 2.4 | 0.5 | 0.1 |
| | 6(A) | | | | | | |
| EXAMPLE 2 | FIGURE | | 5.5 | 3.1 | 2.4 | 0.6 | 0.2 |
| | 6(A) | | | | | | |
| COMPARATIVE | FIGURE | | 5.7 | 3.3 | — | 3.8 | 1.3 |
| EXAMPLE 1 | 6(B) | | | | | | |
| COMPARATIVE | FIGURE | | 5.9 | 5.9 | — | 5.2 | 2.1 |
| EXAMPLE 2 | 6(B) | | | | | | |
| COMPARATIVE | FIGURE | | 5.6 | 3.2 | — | 3.9 | 1.5 |
| EXAMPLE 3 | 6(B) | | | | | | |

From Table 1, it can be seen that, in the device according to the present invention shown in FIG. 6(A), (a) surfactants present in the raw water were well removed by the ion exchange apparatus 32 using a salt-form ion exchange resin, (b) because surfactants did not flow into the organic matter oxidizing device 34, the-removal efficiency of the organic matter at the organic matter oxidizing device 34 was improved, the organic matter remaining in the water flowing out of the organic matter oxidizing device 34 were decomposed to organic acids and/or carbonic acid, and organic matter which could pollute the anion exchange resin did not flow into the anion exchange apparatus 36, and (c) the organic acids and/or carbonic acid were adsorbed and removed by the anion exchange resin of the anion exchange apparatus 36.

On the other hand, for the device shown in FIG. 6(B) in which the ion exchange apparatus 32 using a salt-form ion exchange resin omitted, surfactants flowed into the organic matter oxidizing device 34 and, because the surfactants were not decomposed into organic acids and/or carbonic acid, organic decomposition products of the surfactants with large molecular weights remained in the water flowing out of the organic matter oxidizing device 34. When this water flowed into the anion exchange apparatus 36, the ion exchange resin was polluted by the decomposition products. Because surfactants flowed into the organic matter oxidizing device 34, the removal efficiency of the organic matter at the organic matter oxidizing device 34 was reduced, resulting in insufficient decomposition of the organic matter other than the surfactants into organic acids and/or carbonic acid at the organic matter oxidizing device 34, and in leakage of the insufficiently decomposed organic matter from the anion exchange apparatus 36.

### Examples 3 and 4, and Comparative Examples 4 and 5

Experiments similar to examples 1 and 2 and comparative examples 1 through 3 were performed for raw water with anionic surfactants and cationic surfactants present in a ratio by weight of 1:1. For the ion exchange apparatus 32, a mixed bed of Cl-form gel type strong basic anion exchange resin, AMBERLITE IRA-402BL™ and Na-form gel type strong acidic cation exchange resin, AMBERLITE IR-124™ were used with the mixing and loading ratio of IRA-402BL™:IR-124™ being 3:1 in volume. The TOC concentrations in the raw water, in the water flowing out of the ion exchange apparatus 32, flowing out of the organic matter oxidizing device 34, and flowing out of the anion exchange apparatus 36 are shown in Table 2.

The amount of hydrogen peroxide and ozone added, and the amount of ultraviolet rays irradiated for examples 3 and 4 and comparative examples 4 and 5 were equivalent to the values for the examples 1 and 2 or for the comparative examples 1 through 3. The anion exchange resin used for the anion exchange apparatus 36 was also the same as that for the examples 1 and 2.

| | | | | | TOC CONCENTRATION | | |
|---|---|---|---|---|---|---|---|
| | | | | | OF WATER FLOWING OUT (ppm) | | |
| | | | | | | WATER FLOW- | |
| | USED DEVICE | | TOC CONCENTRATION | | WATER FLOW- | ING OUT OF | WATER FLOW- |
| | | ORGANIC | OF THE RAW WATER (ppm) | | ING OUT OF | THE ORGANIC | ING OUT OF |
| | | MATTER | OVERALL TOC | TOC CONCENTRA- | THE ION EX- | MATTER OXI- | THE ANION EX- |
| | FLOW | OXIDIZING | CONCEN- | TION DUE TO | CHANGE | DIZING DEVICE | CHANGE |
| | DIAGRAM | DEVICE | TRATION | THE SURFACTANTS | APPARATUS 32 | 34 | APPARATUS 36 |
| EXAMPLE 3 | FIGURE | | 11.0 | 9.2 | 1.8 | 0.4 | 0.1 |
| | 6(A) | | | | | | |
| EXAMPLE 4 | FIGURE | | 11.1 | 9.3 | 1.8 | 0.4 | 0.1 |
| | 6(A) | | | | | | |
| COMPARATIVE | FIGURE | | 11.1 | 9.5 | — | 7.2 | 3.2 |
| EXAMPLE 4 | 6(B) | | | | | | |
| COMPARATIVE | FIGURE | | 11.0 | 9.2 | — | 6.9 | 3.5 |
| EXAMPLE 5 | 6(B) | | | | | | |

It can be seen from Table 2 that the cationic and anionic surfactants present in the raw water were well removed by the ion exchange apparatus 32 using a mixed resin of a salt-form strong basic anion exchange resin and a salt-form strong acidic cation exchange resin in the apparatus shown in FIG. 6(A).

On the other hand, in comparative examples 4 and 5 with the ion exchange apparatus 32 omitted, similar to the comparative examples 1 through 3, because surfactants flowed into the organic matter oxidizing device 34, the organic matter was insufficiently decomposed at the organic matter oxidizing device 34, resulting in higher TOC concentrations at the water flowing out of the anion exchange apparatus 36 compared to the TOC concentrations in examples 3 and 4.

As described, according to the organic matter removal apparatus of the embodiment, surfactants and other organic substances present in the water to be treated can effectively be removed, and the surfactants and other organic substances can be prevented from leaking through to the treated water. Moreover, according to the high-purity water producing system of the present invention, because removal of the surfactants and other organic substances at the line for treating the water can be more effectively performed and the surfactants and other organic substances can be prevented from leaking through to the treated water of the line, it is possible to prevent performance reduction of the ion exchange apparatus and reverse osmosis membrane device placed in the high-purity water producing system due to the surfactants, and to prevent surfactant pollution of the environment.

What is claimed is:

1. An organic matter removal apparatus for treating water containing surfactants and other organic substances, comprising,
an ion exchange apparatus using a salt-form ion exchange resin for adsorbing and removing the surfactants present in the water to be treated, through which apparatus is passed the water to be treated having surfactants and other organic substances present therein, and
an organic matter oxidizing device for oxidizing and decomposing the organic matter remaining in the treated water of said ion exchange apparatus.

2. An organic matter removal apparatus according to claim 1, wherein,
the water to be treated is treated at said ion exchange apparatus and the treated water is then treated at said organic matter oxidizing device.

3. An organic matter removal apparatus according to claim 1, wherein,
said salt-form ion exchange resin is a salt-form strong electrolytic ion exchange resin.

4. An organic matter removal apparatus according to claim 1, wherein,
said organic matter oxidizing device oxidizes and decomposes the organic matter present in the water to be treated by adding ozone to the water to be treated under an alkali condition.

5. An organic matter removal apparatus according to claim 1, wherein,
said organic matter oxidizing device oxidizes and decomposes the organic matter present in the water to be treated by adding hydrogen peroxide to the water to be treated and irradiating with ultraviolet rays the water to be treated to which hydrogen peroxide has been added.

6. An organic matter removal apparatus according to claim 1, wherein,
said organic matter oxidizing device oxidizes and decomposes the organic matter present in the water to be treated by adding ozone to the water to be treated and irradiating with ultraviolet rays the water to be treated to which ozone has been added.

7. An organic matter removal apparatus according to claim 1, wherein,
said organic matter oxidizing device oxidizes and decomposes the organic matter present in the water to be treated by adding persulfuric acid and/or a persulfate to the water to be treated as an oxidizing agent and heat treating the water to be treated with the persulfuric acid and/or a persulfate added.

8. An organic matter removal apparatus according to claim 1, wherein,
the surfactants present in said water to be treated are mostly cation surfactants, and
said ion exchange apparatus uses a single bed of a salt-form cation exchange resin.

9. An organic matter removal apparatus according to claim 1, wherein,
the surfactants present in said water to be treated are mostly anion surfactants, and
said ion exchange apparatus uses a single bed of a salt-form anion exchange resin.

10. An organic matter removal apparatus according to claim 1, wherein,
the surfactants present in said water to be treated are mostly cation surfactants and anion surfactants, and
said ion exchange apparatus uses a salt-form cation exchange resin and a salt-form anion exchange resin.

11. An organic matter removal apparatus according to claim 10, wherein,
said ion exchange apparatus uses a mixed bed of a salt-form cation exchange resin and a salt-form anion exchange resin.

12. An organic matter removal apparatus according to claim 10, wherein,
said ion exchange apparatus uses multiple beds of a salt-form cation exchange resin and a salt-form anion exchange resin.

13. A high-purity water producing system for obtaining high-purity water from raw water, comprising,
a high-purity water producing system for producing high-purity water by treating the raw water, and
a waste water recovery system for treating waste water generated at use points by using the high-purity water produced at said high-purity water producing system, and supplying the treated and recovered water, wherein,
said waste water recovery system has
an ion exchange apparatus using a salt-form ion exchange resin for adsorbing and removing surfactants present in the waste water to be treated by said ion exchange resin, through which is passed the water to be treated having surfactants and other organic substances therein, and
an organic matter oxidizing device for oxidizing and decomposing the organic matter remaining in the treated water of said ion exchange apparatus.
